(19) United States
(12) Patent Application Publication
(10) Pub. No.: US 2010/0057839 A1
(43) Pub. Date: Mar. 4, 2010

(54) System and method for distributing design system, design system distributing server, and client system

(75) Inventors: Shigeki Sakai, Kanagawa (JP); Kazuhiro Ando, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/318,686

(22) Filed: Jan. 6, 2009

(30) Foreign Application Priority Data
Sep. 1, 2008 (JP) 2008-002037

(51) Int. Cl. G06F 15/16

(52) U.S. Cl. 709/203

(57) ABSTRACT

In a design-system distributing method, when a server side design system is updated, a server compares an updated server side design system and a client update state data, and the server distributes an update assisting system, an update indication data and a difference data to a client system based on the comparing result. The client system stores the update assisting system, the update indication data and the difference data, and the client system starts the stored update assisting system such that an update notice is outputted to a user of the client system to urge update of the client side design system each time a preset condition is satisfied until an update command of the client side design system is supplied to the client system. The client system updates the client side design system based on the stored update indication data and the stored difference data in response to the update command. The client system generates and transmits the client update state data to the server to indicate an update state of the client side design system for this time, and the server updates the client update state data based on the client update state data received from the client system.

### INCORPORATION BY REFERENCE

This patent application is based on Japanese Patent Application No. 2008-002037. The disclosure thereof is incorporated herein by reference.

### BACKGROUND OF THE INVENTION

1. Field of the Invention

The present invention relates to a design-system distributing system and a design-system distributing method, and more particularly, relates to a design-system distributing system related to a design system of ASIC (Application Specific Integrated Circuits), a design-system distributing server, and a client system.

2. Description of Related Art

A design system (a program and a library) for an ASIC circuit on a client side should be updated each time a design system on a server side is updated (versioned up). For this purpose, the newest design system is distributed from the server side to the client side of a user, who is asked to perform an update operation.

The following technique is disclosed with regard to update of software on the client side by the server side. That is, Japanese Patent Application Publication (JP-P2001-282544A) discloses an equipment managing system. In the equipment managing system, the server acquires the software and hardware data of the user in advance. When the software should be updated, the server determines the client as a destination whose software should be updated, based on the determined data, and transmits the updated software to the determined client along a predetermined update schedule. The user installs the updated software. However, the installing (updating) procedure is not clearly described.

Japanese Patent Application Publication (JP-P2000-259519A) discloses a network system. When the update of software is required in the network system, a server transmits a software update data to each of clients. The client transmits a download request to the server in accordance with the software update data and downloads the updated software, when the software of an update target is stopped. If the software of the update target is operating, a warning screen is displayed, and whether or not the operation is completed in a constant time interval is checked. Then, after the completion of the operation, a download request is automatically outputted to the server. That is, the update is performed when the software of the update target in the client is stopped.

Japanese Patent Application Publication (JP-P2003-6084A) discloses a data updating method in a network system. In the data updating method, a data server performs a data updating process on a home server. When each terminal apparatus tries an access, the home server performs the data updating process on each terminal apparatus. That is, the update of software is forcedly performed on each terminal apparatus.

Japanese Patent Application Publication (JP-P2004-362287A) discloses a data updating method. In the data updating method, when updating a dictionary in accordance with a dictionary update notice from a server, a client transmits an update request to a server. The server transmits a difference data to the client. That is, unless the client issues the update request to the server, the update is not performed.

In a system that the newest design system is transmitted to a user who requests an update, there is a case that the user forgets the update. In such a case, an important problem of the design system to be solved through the update is considered to remain in the design system, depending on the content of the update. Also, when a previous update operation has not been performed and the data for a next update operation is transmitted, a plurality of updating operations are required to be performed. Thus, in this case, the no update operation is possibly generated.

On the other hand, when a server forcedly updates the design system of the user, the following problems are considered. That is, at a timing at which the user intends, for example, when the user is using the design system to perform a design, there is a case that the design system is updated to the newest design system. In such a case, there is a possibility that design data in the course of design is damaged or a trouble is generated in the design data before and after the design system is updated.

That is, a system is desired in which on the basis of the convenience of the design of the user, the design system can be updated while a load and a time are suppressed, and update can be prevented.

### SUMMARY

In an aspect of the present invention, a design-system distributing method is achieved by, when a server side design system is updated, a server comparing an updated server side design system and a client update state data; by the server distributing an update assisting system, an update indication data and a difference data to a client system based on the comparing result, the difference data containing a necessary file data indicating necessary files which are necessary to update a client side design system; by the client system storing the update assisting system, the update indication data and the difference data; by the client system starting the stored update assisting system such that an update notice is outputted to a user of the client system to urge update of the client side design system each time a preset condition is satisfied until an update command of the client side design system is supplied to the client system; by the client system updating the client side design system based on the stored update indication data and the stored difference data in response to the update command; by the client system generating and transmitting the client update state data to the server to indicate an update state of the client side design system for this time; and by the server updating the client update state data based on the client update state data received from the client system.

In another aspect of the present invention, a design system distributing server includes: a client update data database to store a client update state data indicating an update state of a client side design system in a client system; a difference data generating section configured to compare, when a server side design system is updated, the updated server side design system with the client update state data to generate a difference data which contains a necessary file data which specifies necessary files necessary to update the client side design system; an update indication data generating section configured to extract the necessary files, and generate an update indication data which contains the necessary files; and a distributing section configured to distribute the update indication data, the difference data and an update assisting system to the client system, such that the client side design system is updated based on the update indication data and the difference data by using the update assisting system.

In still another aspect of the present invention, a client system includes: a storage section configured to store an update indication data, a difference data and an update assisting system; an update confirming section started by the stored update assisting system and configured to output an update notice to a user every time a preset condition is satisfied to urge the update of a client side design system until an update command of the client side design system is supplied to the client system; an updating section configured to update the client side design system based on the stored update indication data and the stored difference data, which contains a necessary file data of files necessary to update the client side design system, in response to the update command; and an update data generating section configured to generate a client update state data to indicate the client side design system after the update for this time in response to the update of the client side design system.

According to the present invention, it is possible to update the design system while the labor and the time are suppressed, on the basis of the convenience of the design of the user, and possible to distribute the design system so that the generation of the update leakage can be protected.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a block diagram showing a configuration of a design-system distributing system according to an embodiment of the present invention;

FIG. 2 is a block diagram showing a configuration of a server in the design-system distributing system according to the embodiment of the present invention;

FIG. 3 is a block diagram showing a configuration of a client system in the design-system distributing system according to the embodiment of the present invention;

FIG. 4 is a flowchart showing an operation of the design-system distributing system according to the embodiment of the present invention;

FIG. 5 is a diagram showing one example of a server side design system before an update;

FIG. 6 is a view showing one example of the server side design system after the update;

FIG. 7 is a diagram showing one example of an update data in the server side design system before and after the update shown in FIGS. 5 and 6;

FIG. 8 is a diagram showing one example of a client side design system before the update;

FIG. 9 is a diagram showing one example of the client side design system after the update;

FIG. 10 is a diagram showing one example of the server side design system after a next update;

FIG. 11 is a diagram showing one example of update data in the server side design system before and after the update shown in FIGS. 5 and 10; and

FIG. 12 is a diagram showing one example of the client side design system after the update.

### DESCRIPTION OF THE PREFERRED EMBODIMENTS

Hereinafter, a design-system distributing system according to the present invention will be described in detail with reference to the attached drawings.

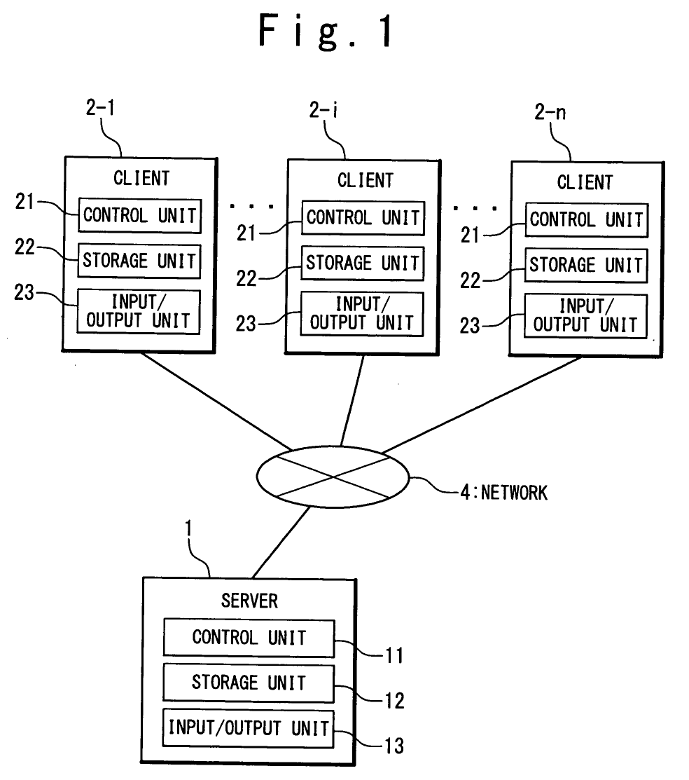

FIG. 1 is a block diagram showing the configuration of the design-system distributing system according to an embodiment of the present invention. Referring to FIG. 1, a design-system distributing system 10 contains a server 1 and a plurality of client systems 2-1 to 2-n.

The server 1 is an information processing apparatus exemplified by a workstation. The server 1 contains a control unit 11 exemplified by a CPU (Central Processing Unit), a storage unit 12 exemplified by an HDD (Hard Disk Drive), and an input/output unit 13 for performing data distribution and input/output of data. The client system 2-i (i is a natural number between 1 and n) is an information processing apparatus exemplified by a workstation and a personal computer. The client system 2-i contains a control unit 21 exemplified by a CPU, a storage unit 22 exemplified by an HDD, and an input/output unit 23 for performing data distribution and input/output of data. The server 1 and the client systems 2-i are connected through a network 4 exemplified by the Internet so that a two-way communication can be performed.

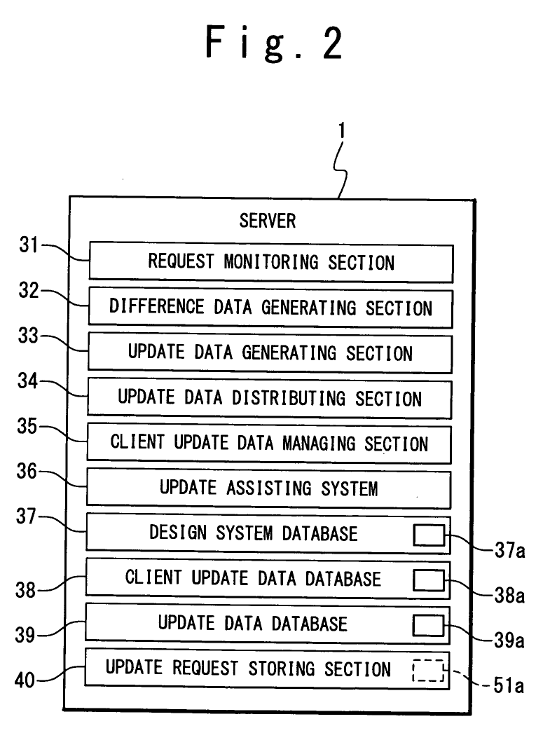

FIG. 2 is a block diagram showing the configuration of the server 1 according to the embodiment of the present invention. The server 1 includes a request monitoring section 31, a difference data generating section 32, an update data generating section 33, an update data distributing section 34, a client update data managing section 35, an update assisting system 36, a design system database 37, a client update data database 38, an update data database 39 and an update request storing section 40.

Each of them can be constituted with software, hardware or the combination of them. For example, the request monitoring section 31, the difference data generating section 32, the update data generating section 33, the update data distributing section 34, the client update data managing section 35 and the update assisting system 36 are stored as portions of a program in the storage unit 12 and executed by the control unit 11. The program is recorded in a recording medium and loaded into the server 1. A predetermined directory is assigned to the update request storing section 40 as a storage area for a data (it may be a predetermined area in the storage unit 12).

The design system database 37 relates a server side design system 37a and a server side design system specifying data 37b to specify the server side design system 37a and stores a set of them. The server side design system 37a is the design system for ASIC among the design systems of a plurality of kinds possessed by the server 1. The ASIC design system is provided with a text file, and an object file (binary file) after it is converted by a compiler for C-language.

The client update data database 38 relates a client update state data 38a and a client side design system specifying data to specify the client side design system 55a and stores a set of them. The client update state data 38a indicates an update state of the client side design system as the ASIC design system possessed by the client system 2-i. The client update state data 38a has file data indicating all the files of the client side design system 55a installed under a predetermined environment variable of the client system 2-i (Exemplification: Directory Path+File Name, Its File Size, and Data of Time Stamp of File), and the data to specify the client system 2-i (Exemplification: Client System Name and Client System Authentication Number). The update states of the client side design systems in all the client systems 2-1 to 2-n can be grasped by the server 1 side from the client update data database 38.

The update data database 39 relates an update indication data 39a and the server side design system specifying data, and stores a set of them. The update indication data 39a indicates that the server side design system 37a has been updated. The update indication data 39a includes a data related to the update such as an installation site (Exemplification: Directory Specified by Predetermined Environment Variable) of the updated server side design system, an update date, an update content, and an update reason.

The update request storing section 40 relates an update request data and the client side design system specifying data to specify the client system 2-i and stores a set of them. The update request data 51a indicates a request of the update of the client side design system (this will be described later). For example, the update request data 51a includes the data indicating a client system name, a client system authentication number, and a series (a small classification inside the design system) name whose update is desired.

The request monitoring section 31 checks whether or not the update indication data 39a stored in the update data database 39 of the server 1 or the update request data 51a stored in the update request storing section 40 is updated in a certain time interval. If any one of the data is determined to be updated, the request monitoring section 31 outputs a data indicating this fact to the difference data generating section 32.

The difference data generating section 32 refers to the server side design system database 37 and the client update data database 38 in response to the update (the update indication data 39) of the server side design system 37a. Subsequently, the difference data generating section 32 extracts all the client side design system specifying data corresponding to the server side design system specifying data of the updated server side design system 37a. After that, the client update state data 38a is taken out for each of all the extracted client side design system specifying data, and the client update state data 38a is compared with the updated server side design system 37a. Thus, a difference data 32a is generated which includes a necessary file data and an unnecessary file data. That is, the difference data 32a is generated for each of all of the extracted client side design system specifying data. However, the necessary file data specifies necessary files necessary to update the client side design system 55a. The unnecessary file data specifies unnecessary files unnecessary to update the client side design system 55a.

In this way, when the server side design system 37a is updated, all of the client side design system specifying data related to the update are extracted. When the subsequent steps are executed, the update can be executed without any reminder for all the client side design systems related to the update. The case of one client side system will be described below.

It should be noted that the difference data generating section 32 instructs only the client system 2-i transmitting the update request data 51a to update the client side design system.

The update data generating section 33 refers to the server side design system database 37 in accordance with the difference data, and extracts the necessary files corresponding to the necessary file data, and then generates an update indication data.

The update data distributing section 34 distributes the update indication data, the difference data 32a, an update guide data (this will be described later) and the update assisting system 36 to the client system 2-i corresponding to the client side design system 55a. Here, the update guide data 41 is a notice that indicates transmission of a file to update the client side design system 55a, and this is exemplified by an e-mail. The update assisting system 36 assists the update of the client side design system 55a.

The client update data managing section 35 updates the client update state data in the client update state data database 38 in accordance with a client update state data outputted from the client system 2-i. That is, a previous client update state data is deleted and replaced with the newest client update state data transmitted from the client system 2-i. Here, the client update state data 54a indicates the update state of the client side design system 55a updated in accordance with the newest one of the update indication data 33a and the difference data 32a.

The update assisting system 36 outputs an update notice which urges the update of the client side design system 55a in accordance with the newest one of the update indication data 33a and the difference data 32a in the client system 2-i each time a preset condition is satisfied, until a command for updating the client side design system 55a is received. The preset condition is exemplified by a time when the client system 2-i is started or ended or by a time when the client side design system 55a is started or ended.

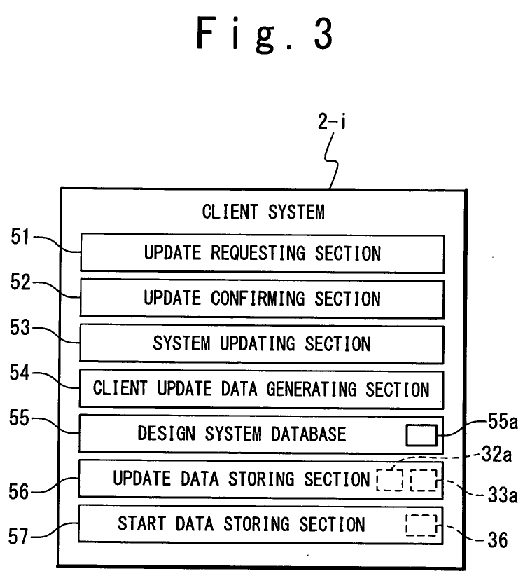

FIG. 3 is a block diagram showing the configuration of the client system according to the embodiment of the present invention. The client system 2-i includes an update requesting section 51, an update confirming section 52, a system updating section 53, a client update data generating section 54, a design system database 55, an update data storing section 56 and a start data storing section 57.

Each of them can be configured in software, hardware or a combination of them. For example, the update requesting section 51, the update confirming section 52, the system updating section 53 and the client update state data generating section 54 are stored as portions of a program in the storage unit 22 and executed by the control unit 21. The program is recorded in a recording medium and is loaded into the storage unit 22. The design system database 55 is stored as a program and data in the storage unit 22 and controlled by the control unit 21. A predetermined area of the storage unit 21 is assigned as a storing area of the data to the update data storing section 56. A predetermined directory as a storing area of the data (it may be a predetermined area of the storage unit 22) is assigned to the start data storing section 57. The predetermined directory is referred each time a preset condition is satisfied, and the program held therein is executed. For example, it is a directory referred when the client system 2-i is started or ended, or a directory referred when the client side design system 55a is started or ended.

The client side design system 55a and the client side design system specifying data are related and stored in the design system database 55. The client side design system 55a is an ASIC design system of the client system 2-i and corresponds to one of the plurality of server side design systems 37a. The client side design system specifying data specifies the client side design system 55a, and this is exemplified by an identifier (ID).

The update data storing section 56 stores the update indication data 33a and the difference data 32a transmitted from the server 1. Also, when the update indication data 33a and the difference data 32a are newly received, they may be overwritten on the previously-received update indication data 33a and difference data 32a. In this case, the previously-received update indication data 33a and difference data 32a are deleted. That is, the update data storing section 56 stores the newest update indication data 33a and difference data 32a.

The start data storing section 57 stores the update assisting system 36 transmitted from the server 1. Also, when the update assisting system 36 is newly received, it may be overwritten on the previously-received update assisting system 36. In this case, the previously-received update assisting system 36 is deleted. That is, the start data storing section 57 stores the newest update assisting system 36.

When the user requests the update of the client side design system 55a, the update requesting section 51 generates the update request data 51a in response to the request. Then, the update request data 51a is related to a client side design system specifying data and transmitted to the server 1.

The update confirming section 52 is started by the update assisting system 36 transmitted by the server 1 and outputs the update notice each time the foregoing preset condition is satisfied, until the update of the client side design system 55a is requested. Here, the update notice urges the user to update the client side design system 55a on the basis of the newest one of the update indication data 33a and difference data 32a. This is displayed on a display unit of the client system 2-i.

The system updating section 53 updates the client side design system 55a of the client side design system database 55 on the basis of the newest one of the update indication data 33a and difference data 32a in response to a command of the update. For example, the necessary files of the difference data 32a are overwritten on corresponding files of the client side design system database 55. The files of the client side design system database 55 are deleted which corresponds to the unnecessary files of the difference data 32a.

The client update data generating section 54 generates the client update state data 54a indicating the update state of the client side design system 55a for this time in response to the update of the client side design system 55a. The client update state data 54a includes a data to specify all the files included in the client side design system 55a. Then, the client update state data 54a is transmitted to the server 1.

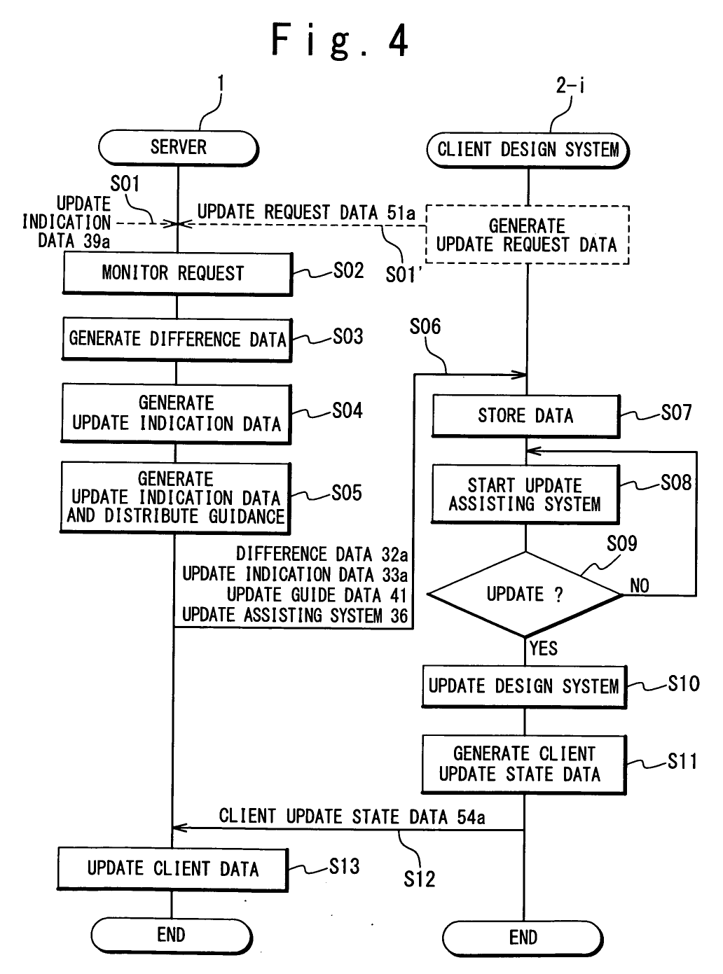

FIG. 4 is a flowchart showing the operation of the design-system distributing system according to the embodiment of the present invention. Here, the client system 2-i will be described among a plurality of client systems 2-i, 2-j, 2-k, . . . (1≦j and k≦n) having the client side design system 55a of the update target.

When the user of the ASIC design system updates the server side design system 37a, the server side design system 37a and the update indication data 39a are related to the server side design system specifying data and transmitted through ftp (file transfer protocol) to the server 1 (Step S01). The server side design system specifying data and the server side design system 37a are stored in the design system database 37, and the update indication data 39a are stored in the update data database 39.

The request monitoring section 31 in the server 1 checks whether the update indication data 39a stored in the update data database 39 has been updated in a constant time interval. If it is confirmed that any one of the data has been updated, the request monitoring section 31 outputs a data indicating the above fact to the difference data generating section 32 (Step S02).

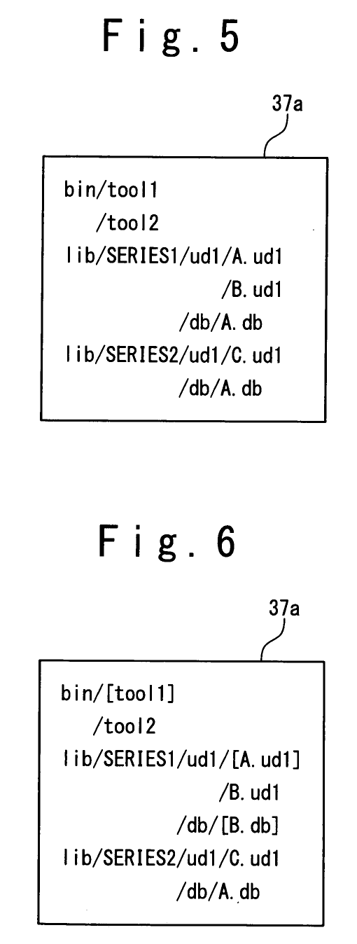

FIG. 5 is a diagram showing one example of the server side design system before the update. In the server side design system 37a before the update, “tool1” and “tool2” as tools are stored in a directory “bin”. Also, in the directory “lib” as a library of “SERIES1”, “A.ud1” and “B.ud1” are stored in the directory “ud1”, and “A.db” is stored in the directory “db”. In the directory “lib” as a library of “SERIES2”, “C.ud1” is stored in the directory “ud1”, and “A.db” is stored in the directory “db”. This is equal to the client side design system 55a before the update shown in FIG. 8.

FIG. 6 is a diagram showing one example of the server side design system after the update. In the server side design system 37a after the update, “tool1” is updated in the directory “bin” and represented by [tool1] for the sake of the easy understanding on the drawing. Also, “A.ud1” of “SERIES1” is updated in the directory “lib” and represented by [A.ud1] for the sake of the easy understanding on the drawing. Also, “A.db” is deleted, and “B.db” is added and represented by [B.db] for the sake of the easy understanding on the drawing. This is also a target of updating the client side design system 55a.

With reference to FIG. 4, the difference data generating section 32 refers to the server side design system database 37 in response to the update of the server side design system 37a, and acquires the server side design system specifying data of the updated server side design system 37a. Subsequently, the difference data generating section 32 refers to the client update data database 38 and extracts the same client side design system specifying data as the acquired server side design system specifying data. Thus, the client side design system of the update target is acquired.

After that, the client update state data 38a is extracted which corresponds to the extracted client side design system specifying data. In succession, the extracted client update state data 38a is compared with the updated server side design system 37a. After that, the necessary files necessary for the update (the update target file) and the unnecessary files unnecessary for the update (the deletion target file) are extracted based on the comparison result, in order that the client side design system 55a corresponding to the client side design system specifying data is made equal to the updated server side design system 37a. Then, the difference data 32a is generated, which includes the necessary file data indicating the necessary files and the unnecessary file data indicating the unnecessary files (Step S03).

Specifically, the difference data 32a can be generated as follows. That is, at the time of the comparison, the difference data generating section 32 firstly outputs a directory path name+a file name, its file size, and a data of a time stamp of the file to the text file for each of the files of the design system under a predetermined environment variable with regard to the updated server side design system 37a. Then, the outputted content is compared with the same data portion in the client update state data 38a. At that time, with regard to the certain file, if the file name is same but the file size is different so that the client is old in the time stamp, the file is determined to be an update target. On the other hand, if all of them are same, the file is determined to be not the update target. Moreover, if there is a file existing only in the updated server side design system 37a, the file is determined to be an update target. If there is a file existing only in the client update state data 38a (client side design system 55a), it is determined to be a file that should be deleted from the client side design system 55a. In accordance with the foregoing determination, the text file that describes an identifier (indicating the update target or deletion target)+the file name (including the directory path) of the update target or deletion target is generated as the difference data 32a for all of the update target files and the deletion target files.

With reference to FIGS. 5 and 6, the difference data 32a includes the following data from the server side design system before and after the update:
Update Identifier+bin/[tool1]
Update Identifier+lib/SERIES1/ud1/[A. ud1]
Update Identifier+lib/SERIES1/db/[B. db]
Deletion Identifier+lib/SERIES1/db/A. db

The update data generating section 33 refers to the server side design system database 37 in accordance with the difference data 32a and extracts the necessary files (a main body of the files) corresponding to the necessary file data. Then, the update indication data 33a including all of the necessary files is generated (Step S04). That is, the update data generating section 33 refers to the identifier of the difference data 32a and recognizes the necessary files (update target files). Then, these necessary files (files themselves) are collected from the file group of the updated server side design system 37a and defined as one update indication data 33a.

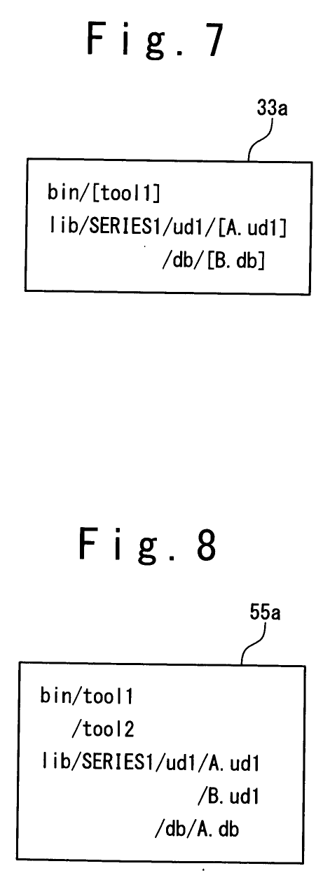

FIG. 7 is a diagram showing one example of the update indication data 33a when the server side design systems are as shown in FIGS. 5 and 6. The update indication data 33a includes [tool1] updated in the directory “bin”; [A.ud1] updated in the directory “lib/SERIES1/ud1”; and [B.db] added (updated) in the directory “lib/SERIES1/db”, as the necessary files necessary for the update. Also, “A.db” deleted in the directory “lib/SERIES1/db” is described in the difference data 32a as mentioned above.

With reference to FIG. 4, the update data distributing section 34 distributes the update indication data 33a, the difference data 32a, the update guide data 41 and the update assisting system 36 through ftp to the client system 2-i corresponding to the client side design system 55a (Step S05). The update guide data 41 is distributed by e-mail to a predetermined mail address of the client system 2-i. The content of e-mail is exemplified in the update content that the server side design system is updated and as the result, the client side design system is required to be updated. The content of the update is quoted from the update indication data 39a. In this way, for the sake of the update, the server side design system 37a itself is not transmitted, and the update indication data 33a and the difference data 32a are transmitted, which can reduce the data amount to be transmitted.

The update indication data 33a, the difference data 32a, the update guide data 41 and the update assisting system 36 are transmitted through a network 4 (Step S06). The update data storing section 56 stores the update indication data 33a and the difference data 32a transmitted from the server 1. The start data storing section 57 stores the update assisting system 36 transmitted from the server 1 (Step S07). At this time, when newly receiving a new update indication data 33a and the difference data 32a, the update data storing section 56 overwrites on a previously-received update indication data 33a and difference data 32a and holds them, if there are the previously-received update indication data 33a and difference data 32a. Similarly, when newly receiving the update assisting system 36, the start data storing section 57 overwrites on a previously-received update assisting system 36 and holds it, if there is the previously-received update assisting system 36. Thus, it is possible to always hold the update assisting system 36, the update indication data 33a and the difference data 32a, with regard to the newest update.

The update confirming section 52 is started by the update assisting system 36, each time a preset condition is satisfied. Then, an update notice for urging the user to update the client side design system 55a is outputted until the reception of a command for updating the client side design system 55a (Step S08). The display unit in the client system 2-i displays the update notice. The preset condition is exemplified by a case where the client system 2-i is started or ended, or by a case where the client side design system 55a is started or ended.

For the update notice displayed in the client system 2-i, the user selects whether to perform the update (Step S09). If the user does not perform the update for this time (Step S09: No), the update confirming section 52 is started by the update assisting system 36, each time the preset condition is satisfied, and outputs the update notice for urging the user to update the client side design system 55a (Step S08).

When the user performs the update for the update notice displayed in the client system 2-i (Step S09: Yes), the user inputs the command of the update to the client system 2-i. The system updating section 53 updates the client side design system 55a of the client side design system database 55 on the basis of the newest one of the update indication data 33a stored in the update data storing section 56 and the difference data 32a stored in the start data storing section 57 in response to the command of the update and (Step S10). For example, the necessary files of the difference data 32a are overwritten on the corresponding files in the client side design system database 55. Thus, the files of the client side design system database 55 are deleted which corresponds to the unnecessary files data of the difference data 32a.

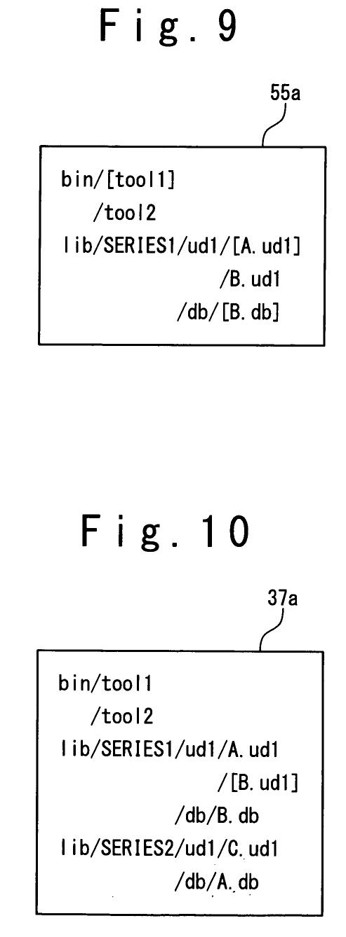

FIG. 9 is a diagram showing one example of the client side design system after the update. In the server side design system 37a after the update, “tool1” is updated in the directory “bin” and represented by [tool1] for the sake of the easy understanding on the drawing. Also, “A.ud1” in “SERIES1” is updated in the directory “lib” and represented by [A.ud1] for the sake of the easy understanding on the drawing. Also, “A.db” is deleted, and “B.db” is added and represented by [B. db] for the easy understanding on the drawing. This is equal to the updated server side design system 37a (FIG. 6). However, the server side design system 37a does not have “SERIES2”.

With reference to FIG. 4, the client update data generating section 54 generates the client update state data 54a indicating the update state for this time in the client side design system 55a in response to the update of the client side design system 55a (Step S11). The client update state data 54a includes a data to specify all the files included in the client side design system 55a. The client update state data 54a has the file data of all the files of the client side design system 55a installed under a predetermined environment variable in the client system 2-i (Exemplification: Directory+File name, Its File Size, and Data of Time Stamp of File), and a data to specify the client system 2-i (Exemplification: Client System Name and Client System Authentication Number). Its content is updated by an updating process for this time. Then, the client update state data 54a is transmitted to the server 1 (Step S12).

The client update data managing section 35 updates the client update state data in the client update data database 38 in accordance with the client update state data 54a outputted from the client system 2-i (Step S13). That is, a previous client update state data is deleted and replaced with the newest client update state data transmitted from the client system 2-i.

As mentioned above, the usual update is performed. However, at the step S09, if the client system 2-i does not perform the update (hereinafter, to be referred to as [Update for This Time] (Step S09: No), there is a case that prior to the performance of the update for this time (the performance of the operations at and after the step S10), the new update (hereinafter, to be referred to as [Next Update]) is executed in the server side design system 37a. In that case, since the update in the client system 2-i is not performed, the state prior to the performance of the update for this time is kept in the client update state data 38a. Thus, without considering the performance or non-performance of the update for this time in the client system 2-i, the server 1 may perform the usual operations of the steps S02 to S06 and transmit the update indication data 33a, the difference data 32a, the update guide data 41 and the update assisting system 36 to the client system 2-I, for the sake of the next update. In the client system 2-i, the update confirming section 52 may store the update indication data 33a and the difference data 32a in the update data storing section 56, for the sake of the next update, and may delete (or overwrite and hold) the update indication data 33a and the difference data 32a for the sake of the update for this time, and further store the update assisting system 36 for the next update in the start data storing section 57 and then delete (or write and hold) the update assisting system 36 for the sake of the update for this time.

For example, it is assumed that the update for this time is the update from the server side design system 37a in FIG. 5 to that in FIG. 6 and the next update is the update from the server side design system 37a in FIG. 6 to that in FIG. 10. FIG. 10 is a diagram showing one example of the server side design system after the next update. In the server side design system 37a after the update, “B.ud1” in “SERIES1” is updated in the directory “lib” and represented by [B.ud1] for the sake of the easy understanding on the drawing. At this time, in the client side design system 55a, since the update for this time is not performed, it is still in the state shown in FIG. 8. That is, the client side design system 55a is required to be updated from the state in FIG. 5 to the state in FIG. 10.

In this state, when the server 1 performs the operations of the steps S02 to S06, the difference data 32a in the next update includes the following data:
Update Identifier+bin/[tool1]
Update Identifier+lib/SERIES1/ud1/[A. ud1]
Update Identifier+lib/SERIES1/ud1/[B. ud1]
Update Identifier+lib/SERIES1/db/[B. db]
Deletion Identifier+lib/SERIES1/db/A. db

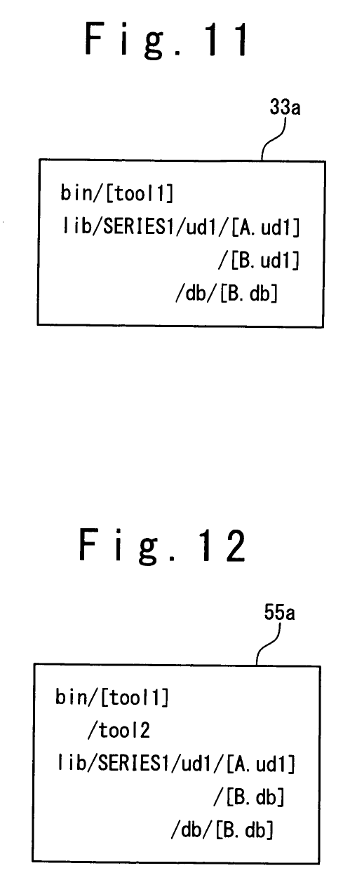

Also, the update indication data 33a in the next update is as follows. FIG. 11 is a diagram showing one example of the update indication data 33a when the server side design systems before and after the update are shown in FIGS. 5 and 10. The update indication data 33a includes: [tool1] updated in the directory “bin”; [A.ud1], [B.ud1] updated in the directory “lib/SERIES1/ud1”; and [B.db] added (updated) in the directory “lib/SERIES1/db”, as the necessary files necessary for the update. Also, “A.db” deleted in the directory “lib/SERIES1/db” is described in the difference data 32a as mentioned above.

FIG. 12 is a diagram showing one example of the client side design system after the update. In the server side design system 37a after the update, “tool1” is updated in the directory “bin” and represented by [tool1] for the sake of the easy understanding on the drawing. Also, “A.ud1” and “B.ud1” in “SERIES1” are updated in the directory “lib” and represented by [A.ud1] and [B.ud1] for the easy understanding on the drawing. Also, “A.db” is deleted and “B.db” is added for the sake of the easy understanding on the drawing. This is equal to the updated server side design system 37a (FIG. 10). However, the server side design system 37a does not have “SERIES2”.

By using the difference data 32a and the update indication data 33a for the next update, all the updates until that moment (both for this time and the next time) can be achieved as mentioned above, if only the newest update is performed. That is, it is possible to perform the update from the state in FIG. 5 to the state in FIG. 10.

It should be noted that when the update request data 51a is transmitted from the client system 2-i to the server 1, the update may be started. For example, the user requests the update of the client side design system 55a on the client system 2-i, and the update requesting section 51 generates the update request data 51a in response to the request. Then, the update request data 51a is related to the client data and transmitted through ftp to the server 1 (Step S01′). The client data and the new request data 51a are stored in the update request storing section 40. The request monitoring section 31 in the server 1 checks whether or not the update request data 51a is stored in the update request storing section 40, at in a constant time interval. If the update request data 51a is stored, the request monitoring section 31 outputs a data indicating the above to the difference data generating section 32 (Step S02). Hereinafter, the similar operations are performed.

In the present invention, when the data related to the update and transmitted from the server 1 is held, the client system 2-i can reject the update of the client side design system once. Consequently, by using the held data related to the update, the user can perform the update when the user desires it. Also, the update is consecutively urged to the user by the update assisting system 36. Thus, the user can be instructed to surely perform the update. That is, it is possible to prevent non-update of the client side design system.

In the present invention, moreover, when the user does not update the client side design system and then the server side design system is newly updated, the data related to the newest update is the data including all the updates. Thus, in the client system 2-i, each update is not required to be individually performed. That is, the user may perform only the new update on the client side design system. Therefore, it is possible to reduce the load to the user and the update time and also possible to prevent the non-update.

In the present invention, the newest client update state data 38a of the client system 2-i exists on the server 1. Thus, it is possible to search the client system 2-i, in which the update is required, inside the server 1, and to generate the update indication data 33a corresponding to the update state of the client side design system 55a. Thus, it is possible to shorten the time between the update of the server side design system 37a in the server 1 and the update request of the client side design system 55a. In addition, not a data for the entire design system but only the data necessary for the update is transmitted, and thereby the load of the network on the data transfer is reduced.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A design-system distributing method comprising:
when a server side design system is updated, a server comparing an updated server side design system and a client update state data;
said server distributing an update assisting system, an update indication data and a difference data to a client system based on the comparing result, said difference data containing a necessary file data indicating necessary files which are necessary to update a client side design system;
said client system storing said update assisting system, said update indication data and said difference data;
said client system starting said stored update assisting system such that an update notice is outputted to a user of said client system to urge update of said client side design system each time a preset condition is satisfied until an update command of said client side design system is supplied to said client system;
said client system updating said client side design system based on said stored update indication data and said stored difference data in response to the update command;
said client system generating and transmitting said client update state data to said server to indicate an update state of said client side design system for this time; and
said server updating said client update state data based on said client update state data received from said client system.

2. The design-system distributing method according to claim 1, further comprising:
said client system updating said update assisting system, said stored update indication data and said difference data, which are stored in a storage section, by said update assisting system, said update indication data and said difference data which are distributed from said server.

3. The design-system distributing method according to claim 2, wherein said difference data includes an unnecessary file data indicating unnecessary files which are unnecessary to update said client side design system,
said client system deleting the unnecessary files in said client side design system based on said stored difference data.

4. The design-system distributing method according to claim 1, further comprising:
said client system transmitting an update request data to said server to request the update of said client side design system; and
said server comparing said server side design system and said client update state data in response to said update request data.

5. A design system distributing server comprising:
a client update data database to store a client update state data indicating an update state of a client side design system in a client system;
a difference data generating section configured to compare, when a server side design system is updated, the updated server side design system with the client update state data to generate a difference data which contains a necessary file data which specifies necessary files necessary to update said client side design system;
an update indication data generating section configured to extract the necessary files, and generate an update indication data which contains the necessary files; and
a distributing section configured to distribute the update indication data, the difference data and an update assisting system to said client system, such that said client side design system is updated based on the update indication data and the difference data by using the update assisting system.

6. The design system distributing server according to claim 5, wherein said difference data generating section generates said difference data which contains an unnecessary file data indicating unnecessary files unnecessary to update said client side design system, such that the unnecessary files are deleted from said client side design system.

7. The design system distributing server according to claim 5, further comprising:
a client update state data managing section configured to update said client update state data stored in said client update data database by a client update state data received from said client system.

8. A client system comprising:
a storage section configured to store an update indication data, a difference data and an update assisting system;
an update confirming section started by the stored update assisting system and configured to output an update notice to a user every time a preset condition is satisfied to urge the update of a client side design system until an update command of said client side design system is supplied to said client system;
an updating section configured to update said client side design system based on the stored update indication data and the stored difference data, which contains a necessary file data of files necessary to update said client side design system, in response to the update command; and
an update data generating section configured to generate a client update state data to indicate said client side design system after the update for this time in response to the update of said client side design system.

9. The client system according to claim 8, wherein said update confirming section deletes the stored update assisting system, the update indication data, and the difference data when the update assisting system, the update indication data and the difference data are newly received from a server.
